(19) United States
(12) Patent Application Publication
(10) Pub. No.: US 2025/0222996 A1
(43) Pub. Date: Jul. 10, 2025

(54) DRIVING MODULE SEPARABLE FROM CABIN AND VEHICLE INCLUDING THE SAME

(71) Applicants: Hyundai Motor Company, Seoul (KR); Kia Corporation, Seoul (KR)

(72) Inventors: Yong Sik Kim, Seoul (KR); Jong Myeong Yun, Suwon-Si (KR); Seo Heon Kim, Seoul (KR); Jae Chun Cho, Seoul (KR)

(73) Assignees: Hyundai Motor Company, Seoul (KR); Kia Corporation, Seoul (KR)

(21) Appl. No.: 18/883,515

(22) Filed: Sep. 12, 2024

(30) Foreign Application Priority Data
Jan. 5, 2024 (KR) 10-2024-0002175

(51) Int. Cl. B62D 63/02; B60K 35/53; B62D 25/20; B62D 27/06; B62D 31/00

(52) U.S. Cl. CPC B62D 63/025; B60K 35/53; B62D 25/2009; B62D 27/06; B62D 31/00

(57) ABSTRACT

A vehicle includes a cabin including an internal space formed on an internal side of the cabin and an opening formed at an end portion of the cabin, and a driving module coupled to the opening of the cabin and configured to supply driving force to the cabin, wherein the driving module includes an independent space formed on an internal side of the driving module in a state of being separated from the cabin.

### CROSS-REFERENCE TO RELATED APPLICATION

The present application claims priority to Korean Patent Application No. 10-2024-0002175, filed on Jan. 5, 2024, the entire contents of which is incorporated herein for all purposes by this reference.

### BACKGROUND OF THE PRESENT DISCLOSURE

### Field of the Present Disclosure

The present disclosure relates to a driving module separable from a cabin and a vehicle including the same.

### Description of Related Art

Traditional vehicles function as a means of transportation. In recent years, an autonomous driving system capable of driving a vehicle without human intervention has become a reality due to development of communication technology and sensing technology. Accordingly, a function of a vehicle may be further expanded from a means of transportation and may be transformed into one communal space.

Additionally, in a smart city, vehicles may serve not only as a simple means of transportation but also as a space that provides people with a relaxation area. Furthermore, vehicles may gather to form a building functioning as a communal space.

Accordingly, it is required to develop a vehicle capable of providing various functions in addition to a means of transportation.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle configured for providing a relaxation area or a communal space in addition to a means of transportation through a cabin and a driving module configured to supply driving force to the cabin and to be separable from the cabin.

In accordance with an aspect of the present disclosure, the above and other objects may be accomplished by the provision of a driving module configured to be separable from or couplable to an end portion of a cabin including an internal side of the cabin and to supply driving force to the cabin when the driving module is coupled to the end portion of the cabin, the driving module including a wheel provided in contact with a ground and configured to supply the driving force, and a housing including the wheel accommodated in the housing and a floor formed on an internal side of the housing, the housing being coupled to the end portion of the cabin, wherein the housing includes an independent space formed on the internal side of the housing in a state of being separated from the cabin.

The housing may include a wheel housing portion configured to accommodate the wheel on an internal side of the wheel housing portion, and a roof portion formed to extend upwards from the wheel housing portion.

The housing may include a sliding rail provided on an internal side of the roof portion thereof, wherein the sliding rail may include a display movably provided thereon and configured to transmit an image.

The display may be hinged to an end portion of the sliding rail to be rotatable about the end portion.

The display is configured, when being located at one end portion of the sliding rail, as a light blocking film and is configured, when being located at the other end portion of the sliding rail, as an electronic display board configured to allow the image to be viewed from outside thereof.

The housing may include an accommodation space provided at an upper end portion thereof and configured to allow a display to be accommodated therein, wherein the display may slide in the accommodation space and may protrude out of the housing to serve as a light blocking film.

The display may be a curved display.

The housing may include a sittable seat provided on the internal side thereof.

The seat may be rotatably provided on the internal side of the housing through a hinge.

The floor may include a flange panel provided on an internal side thereof, wherein the flange panel may slide from the internal side of the floor and may protrude to an external side of the floor.

The flange panel may protrude to the external side of the floor when the driving module and the cabin are separated from each other, expanding the independent space, and may be inserted into the cabin when the driving module and the cabin are coupled to each other.

The wheel housing portion may include a shape protruding toward the cabin, and the wheel housing portion may be coupled to the cabin from an external side of the cabin.

In accordance with another aspect of the present disclosure, there is provided a vehicle including a cabin including an internal space formed on an internal side of the cabin and an opening formed at an end portion of the cabin, and a driving module coupled to the opening of the cabin and configured to supply driving force to the cabin, wherein the driving module includes an independent space formed on an internal side of the driving module in a state of being separated from the cabin.

The driving module may include a wheel provided to be in contact with a ground and configured to supply the driving force, and a housing including the wheel accommodated in the housing and a floor formed on an internal side of the housing, the housing being coupled to the opening of the cabin.

The floor may include a flange panel provided on an internal side thereof and configured to slide from the internal side of the floor to protrude to an external side of the floor, wherein the flange panel may be inserted into the cabin in a state in which the driving module is coupled to the cabin.

The housing may include a wheel housing portion configured to accommodate the wheel on an internal side of the wheel housing portion, and a roof portion formed to extend upwards from the wheel housing portion.

The housing may include a sliding rail provided on an internal side of the roof portion thereof, wherein the sliding rail may include a display movably provided thereon and configured to transmit an image.

The wheel housing portion may include a shape protruding toward the cabin, the cabin may include an indented groove indented inwards and formed at a lower portion of the opening, and the wheel housing portion may be inserted into the indented groove of the cabin, enabling the driving module to be coupled to the cabin.

The cabin may include a lifting portion provided at a lower portion thereof and configured to separate the cabin from a ground, wherein the lifting portion may protrude, when the driving module and the cabin are separated from each other, toward the ground to lift the cabin and may be accommodated in the cabin when the driving module and the cabin are coupled to each other.

The cabin may have openings respectively formed at opposite end portions thereof, and each of the pair of driving modules may be coupled to a corresponding one of the opposite end portions of the cabin to supply the driving force to the cabin.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing a state in which a driving module according to an exemplary embodiment of the present disclosure is separated from a cabin;

FIG. 2 is a diagram showing the driving module coupled to the cabin;

FIG. 3 is a diagram showing the driving module according to the exemplary embodiment of the present disclosure;

FIG. 4 and FIG. 5 are diagrams each showing arrangement of the cabin separated from the driving module;

FIG. 6 is a diagram showing utilization of the driving module separated from the cabin;

FIG. 7 and FIG. 8 are diagrams each showing a cross section taken along line A-A in FIG. 3 and showing an exemplary embodiment of an accommodation method of a display;

FIG. 9 is a diagram showing sliding of a flange panel of a floor of the driving module;

FIG. 10 is a diagram showing a state in which the driving module and the cabin are coupled to each other; and

FIG. 11 is a diagram showing lifting of the cabin in a state in which the cabin is separated from the driving module.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail through exemplary embodiments thereof with reference to the accompanying drawings. Wherever possible, the same reference numbers will be used throughout the drawings to refer to the same or like portions, and redundant descriptions thereof will be omitted.

In describing the exemplary embodiments included herein, when it is determined that a detailed description of publicly known techniques to which the present disclosure pertains may obscure the gist of the present disclosure, the detailed description will be omitted. Furthermore, it should be understood that the accompanying drawings are merely illustrated to easily describe the exemplary embodiments included in the present specification, and therefore, the technical idea included in the present specification is not limited by the accompanying drawings. Furthermore, it should be noted that the accompanying drawings include all modifications, equivalents, and substitutes that fall within the spirit and technical scope of the present disclosure.

Meanwhile, in an exemplary embodiment of the present disclosure, terms such as “first” and/or “second” may be used to describe various components, but the components are not limited by the terms. The terms are used only for distinguishing one component from other components.

In the present specification, an expression in a singular form also includes the plural sense, unless clearly specified otherwise in context.

It should be understood that expressions such as “comprise” and “have” in the present specification are intended to designate the presence of indicated features, numbers, steps, operations, components, parts, or combinations thereof, but do not exclude the presence or addition of one or more features, numbers, steps, operations, components, parts, or combinations thereof.

Hereinafter, the suffixes “module”, “unit”, and “part” for components used in the following description are merely provided for facilitation of preparing the present specification. Therefore, the suffixes themselves do not have significant meanings or roles.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

To control various functions, a controller may include a communication apparatus configured to communicate with another controller or a sensor, a memory configured to store an operating system, a logical command, and input/output information, and one or more processors configured to perform determination, calculation, and the like necessary to control a corresponding function.

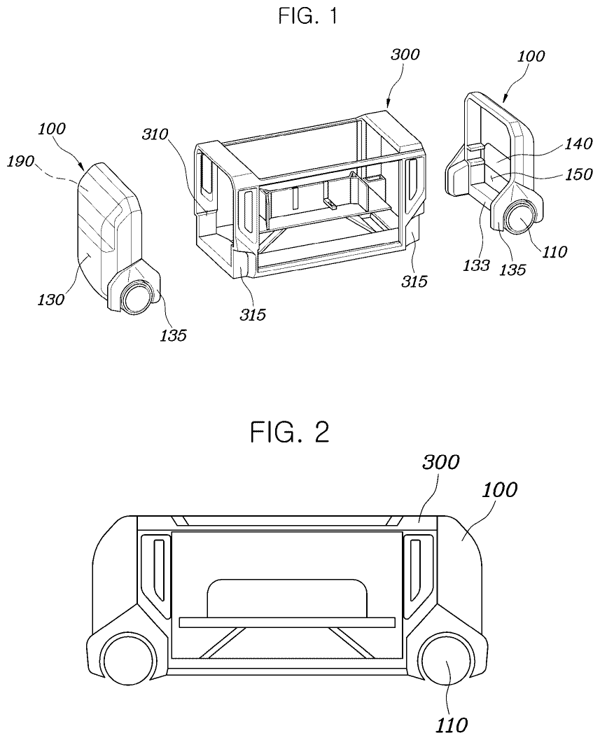

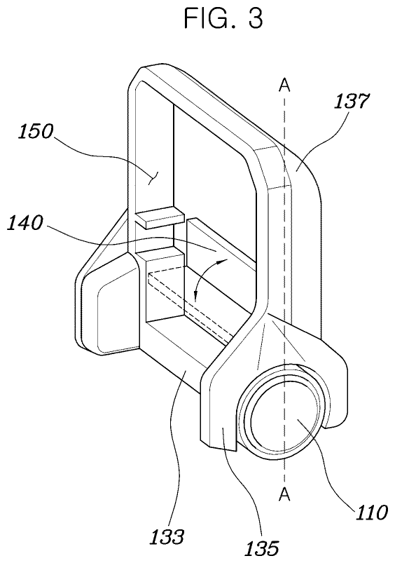

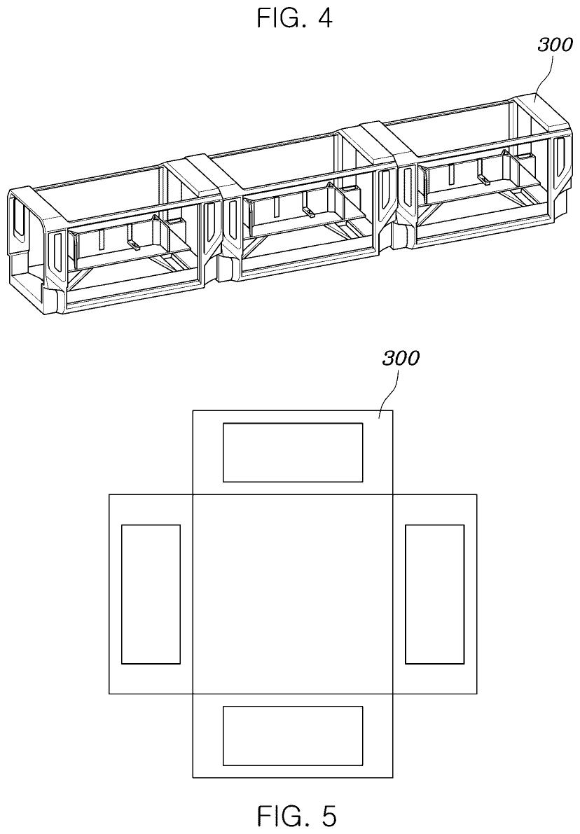

FIG. 1 is a diagram showing a state in which a driving module according to an exemplary embodiment of the present disclosure is separated from a cabin, FIG. 2 is a diagram showing the driving module coupled to the cabin, and FIG. 3 is a diagram showing the driving module according to the exemplary embodiment of the present disclosure.

Referring to FIG. 1, FIG. 2, and FIG. 3, a driving module 100 according to an exemplary embodiment of the present disclosure is attachable to and detachable from a cabin 300. The cabin 300 includes an internal space formed therein and configured to allow a passenger to sit therein or cargo to be loaded therein. Various configurations may be built into the internal space depending on the purpose of the cabin. The cabin 300 itself may have no driving force or may have low driving force configured for driving the cabin 300 at a speed of 30 km/h or less. Accordingly, the driving module 100 may be coupled to the cabin 300 to supply driving force to the cabin 300.

The driving module 100 may be provided with a wheel 110 configured for moving the cabin 300. Furthermore, the driving module 100 may be provided with an electric motor configured for rotating the wheel 110. The cabin 300 may include an auxiliary wheel provided at a lower portion thereof and rotated by driving of the wheel 110 of the driving module 100, in which the auxiliary wheel may not be driven by itself. Furthermore, the cabin 300 may include an auxiliary wheel provided at a lower portion thereof and configured to assist driving thereof at a speed of 30 km/h or less.

Meanwhile, the driving module 100 may include an energy storage device provided therein and configured to supply power to the electric motor, and the cabin 300 may also include an energy storage device provided therein. When the driving module 100 and the cabin 300 are coupled to each other, the energy storage devices respectively provided in the driving module 100 and the cabin 300 are also electrically connected to each other. In the present manner, the energy storage device provided in the cabin 300 may supply power to the electric motor provided in the driving module 100. Additionally, the energy storage device provided in the cabin 300 may be discharged to charge the energy storage device provided in the driving module 100.

Here, a known connector may be used as a means to electrically connect the energy storage devices to each other.

The driving module 100 and the cabin 300 may be coupled to each other by a mechanical method. An opening 310 of the cabin 300 and a housing 130 are coupled to each other. The housing 130 includes a wheel housing portion 135 formed to protrude toward the cabin 300, and the cabin 300 includes an indented groove 315 formed at a lower portion of the opening 310 and indented inwards. Here, the wheel housing portion 135 is inserted into the indented groove 315 of the cabin 300, enabling the driving module 100 to be coupled to the cabin 300.

Additionally, a known method of coupling certain objects to each other may be used to couple the driving module 100 to the cabin 300. For example, the driving module 100 may include a protruding flange formed on one surface thereof, and the cabin 300 may include a groove formed therein and configured to receive the flange. Here, the flange is inserted into the groove, enabling the driving module 100 and the cabin 300 to be mechanically coupled to each other.

Additionally, the driving module 100 and the cabin 300 may be coupled to each other by an electromagnetic method. That is, to couple the driving module 100 to the cabin 300 using electromagnetic force, an electromagnet or a magnetic material may be provided in either the driving module 100 or the cabin 300.

The driving module 100 is coupled to the end portion of the cabin 300. Here, a single driving module 100 may be coupled to one end portion of the cabin 300, or a pair of driving modules 100 may be coupled to the opposite end portions of the cabin 300. When the single driving module 100 is provided, it is desirable for the cabin 300 to be provided with an auxiliary wheel, and when each of the pair of driving modules 100 is coupled to a corresponding one of the opposite end portions of the cabin 300, the cabin 300 does not need to be provided with an auxiliary wheel.

In a case where the auxiliary wheel is provided in the cabin 300, even if the driving module 100 is not usable, the cabin 300 may be moved to a certain extent by force from a person, or the position of the cabin 300 may be finely adjusted by directly controlling the cabin 300.

The driving module 100 may include a driving module controller adopted to control the driving module 100, and the cabin 300 may include a cabin controller adopted to control the cabin 300. Furthermore, separation/coupling between the driving module 100 and the cabin 300 may be performed through each of the controllers.

When the driving module 100 is separated from the cabin 300, the driving module 100 and the cabin 300 may be separated from each other by the controller provided in the driving module 100 or the cabin 300. When the driving module 100 is coupled to the cabin 300, the driving module 100 and the cabin 300 may be coupled to each other through the controller provided in the driving module 100 or the cabin 300.

The driving module 100 is controlled to be moved toward the cabin 300, and a distance between the driving module 100 and the cabin 300 is adjusted to enter a state in which the driving module 100 and the cabin 300 are coupled to each other, making it possible to couple the driving module 100 to the cabin 300.

Meanwhile, when the driving module 100 and the cabin 300 are coupled to each other, a vehicle may be formed to be able to move a passenger sitting in the cabin 300 or cargo loaded in the cabin 300.

When the driving module 100 and the cabin 300 are separated from each other, each of the driving module 100 and the cabin 300 may perform the following functions.

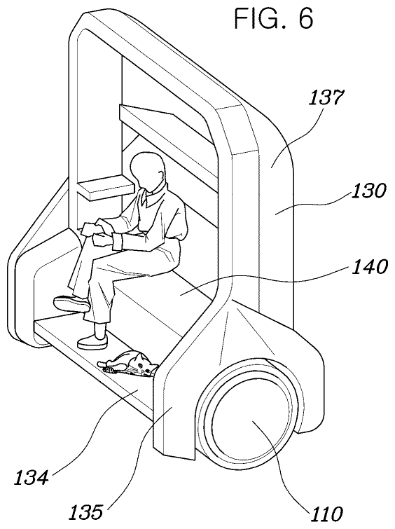

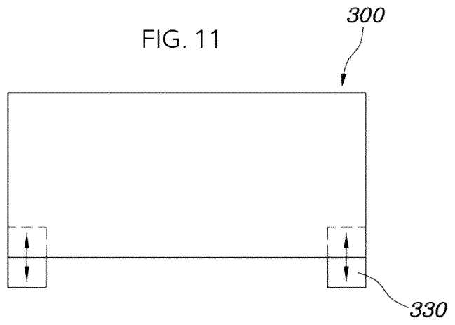

An internal space is formed in the cabin 300. For example, as shown in FIG. 4, a plurality of cabins 300 may be disposed in a straight line. Alternatively, as shown in FIG. 5, a plurality of cabins 300 may be disposed in a square shape to form one communal space. Referring to FIG. 11, the cabin 300 includes a lifting portion 330 provided at a lower portion of the cabin 300 and configured to separate the cabin 300 from the ground. When the driving module 100 and the cabin 300 are separated from each other, the lifting portion 330 protrudes toward the ground and lifts the cabin 300. When the driving module 100 and the cabin 300 are completely coupled to each other, the lifting portion 330 may be accommodated in the cabin 300.

The cabin 300 may form various communal spaces depending on what objects are loaded in the cabin 300. For example, when a new promotional product of a company is loaded in the cabin 300, the cabin 300 may function as a pop-up store. Alternatively, when art is displayed in the cabin 300, the cabin may function as an art museum. As shown in FIG. 5, it is also possible to generate a space in the center portion by arranging four cabins 300 vertically and horizontally, making it possible to use the central space for private purposes.

The driving module 100 supplies driving force to the cabin 300, and the driving module 100 itself also forms an independent space 150 separated from the cabin 300. As described above, the driving module 100 includes a function of not only supplying driving force to the cabin 300 but also forming an independent space.

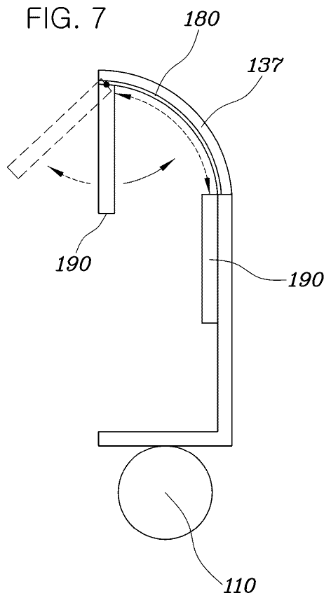

For example, as shown in FIG. 6, the driving module 100 may form a private space suitable for one or two people. The driving module 100 may be used as an independent means of transportation by use of the wheel 110 built into the driving module 100 itself.

The driving module 100 may include a balancing sensor embedded therein and configured to enable the driving module 100 to stably move or stop on the ground when the driving module 100 moves or stops. Furthermore, when the driving module 100 is separated from the cabin 300 and stops on the ground, the driving module 100 may use a support pin provided therein and configured to erect the driving module 100 on the ground. Here, when the driving module 100 stops, the support pin protrudes toward the ground to stably support the driving module 100 on the ground.

In the present manner, when the cabin 300 and the driving module 100 are coupled to each other, a vehicle may be used as a means of transportation. Furthermore, when the cabin 300 and the driving module 100 are separated from each other, the cabin 300 itself may form a communal space, and the driving module 100 itself may provide a relaxation area.

Hereinafter, a configuration of the driving module 100 will be described. The driving module 100 includes the wheel 110 and the housing 130, and the wheel 110 supplies driving force to the driving module 100 and the cabin 300. The wheel 110 is accommodated on the internal side of the housing 130, and specifically, the wheel is accommodated in the wheel housing portion 135 configured to accommodate the wheel therein.

Additionally, the housing 130 includes a roof portion 137 formed to extend upwards from the wheel housing portion 135 and configured to form the driving module 100 or a vehicle roof.

Referring to FIG. 3, one surface of the housing 130 is indented inwards and opened, forming the independent space 150 in the open space. The roof portion 137, the wheel housing portion 135, and a floor 133 of the housing 130 form the independent space of the housing 130. One surface of the housing 130 may be coupled to the cabin 300 to connect the internal space of the cabin 300 to the independent space 150 of the housing 130.

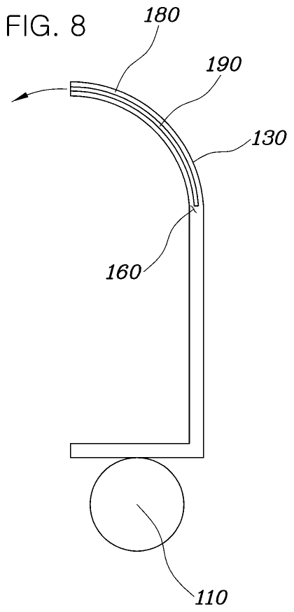

FIG. 7 is a diagram schematically showing a cross section taken along line A-A in FIG. 3. Referring to FIG. 7, the driving module 100 may include a display 190 provided therein and configured to transmit an image. A passenger in the vehicle or the driving module 100 may watch various videos such as movies or advertisements through the display 190.

The display 190 may be provided to be movable within the housing 130 of the driving module 100. The housing 130 includes a sliding rail 180 provided on the internal side thereof, and the sliding rail 180 is provided on the internal side of the roof portion 137. The display 190 may be provided to be movable along the sliding rail 180. Accordingly, the display 190 is movable within a section in which the sliding rail 180 is formed.

The display 190 may perform various functions in the driving module 100 or the vehicle. For example, when the display 190 is located at the other end portion of the sliding rail 180 in a vehicle state in which the cabin 300 and the driving module 100 are coupled to each other, the display 190 is configured as an electronic display board that allows a still image or a video image to be viewed from outside thereof.

That is, the display 190 is located at the rear portion of the vehicle and is in contact with the housing 130 of the driving module 100. In the present manner, a still image or a video image may be viewed from outside through a transparent window formed in the housing 130.

A user may input a destination of the vehicle, may input a function of the vehicle, or may play an advertisement on the display 190.

In the vehicle state in which the cabin 300 and the driving module 100 are coupled to each other, when the display 190 is located at one end portion of the sliding rail 180, a still image or a video image may be transmitted for a passenger sitting in the driving module 100.

As an exemplary embodiment of the present disclosure, in a state in which the cabin 300 and the driving module 100 are separated from each other, the display 190 may be located at one end portion of the sliding rail 180 to transmit a still image or a video image to a passenger sitting in the driving module 100. At the instant time, the display 190 may also serve as a light blocking film. That is, the display 190 covers a portion of an open portion of the housing 130, provided as a light blocking film.

Furthermore, the display 190 may be coupled to the sliding rail 180 hingedly, enabling rotation of the display 190 at one end portion of the sliding rail 180. In the present manner, the display 190 is rotatable at various angles to completely block light from outside according to user's preference.

As described above, the display 190 provided in the driving module 100 may be provided in the independent space 150. However, according to another exemplary embodiment of the present disclosure, the housing 130 may include an accommodation space 160 provided therein and configured to allow the display 190 to be accommodated therein. The accommodation space 160 is provided at the upper end portion of the housing 130. The display 190 may be accommodated in the housing 130 by sliding of the display 190 or may be used by causing the display 190 to protrude out of the housing 130.

Referring to FIG. 8, the accommodation space 160 is provided in the housing 130, the sliding rail 180 is provided in the accommodation space 160, and the display 190 is coupled to the sliding rail 180. In the present manner, the display 190 may slide on the sliding rail 180 to be accommodated in the accommodation space 160. Furthermore, the display 190 may be used in a state of protruding out of the accommodation space 160. Additionally, the display 190 may protrude out of the accommodation space 160 to serve as a light blocking film.

The display 190 may be a curved display including a curved surface, and the shape of the accommodation space 160 formed in the housing 130 may be different depending on the shape of the display 190.

Meanwhile, referring to FIGS. 3 and 6, the housing 130 may include a seat 140 provided on the internal side thereof and configured to allow a passenger to be seated thereon. The seat 140 may be provided in the housing 130 to be rotatable in the housing 130 through a hinge. Accordingly, the seat 140 on which a passenger may sit may be provided in the independent space 150 of the driving module 100. In the present manner, the seat 140 in a vehicle may be provided.

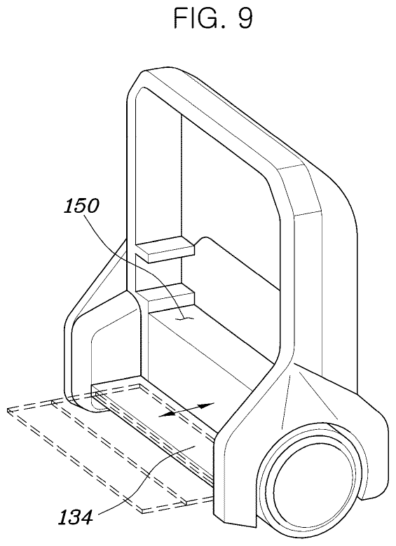

Additionally, the floor 133 may include a flange panel 134 provided on the internal side thereof and configured to slide from the internal side of the floor 133 to protrude to the external side of the floor 133. Referring to FIGS. 3, 6, and 9, the flange panel 134 may protrude to the external side of the floor 133 when the driving module 100 and the cabin 300 are separated from each other, expanding the independent space 150. That is, the flange panel 134 may protrude to the external side of the floor 133 to provide the additional independent space 150, making it possible to provide a space for extra luggage of a passenger, a space for the feet of a passenger, or a space for a pet of a passenger.

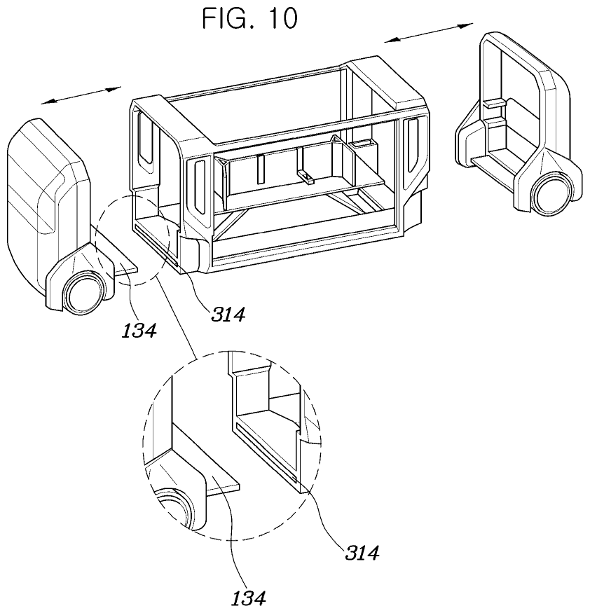

Referring to FIG. 10, the flange panel 134 may be inserted into the cabin 300 when the driving module 100 and the cabin 300 are coupled to each other. Furthermore, when coupling between the driving module 100 and the cabin 300 is in progress, the flange panel 134 may be inserted into the cabin 300, enabling more stable coupling therebetween in a state in which the driving module 100 and the cabin 300 are coupled to each other.

When the driving module 100 and the cabin 300 are coupled to each other, the wheel housing portion 135 may be inserted into the external side of the cabin, and the housing 130 and the cabin 300 may be coupled to each other. In the instant case, the flange panel 134 may be also inserted into a panel insertion groove 314 formed in the cabin 300, stably supporting a coupling state between the driving module 100 and the cabin 300.

The vehicle according to an exemplary embodiment of the present disclosure includes the cabin 300 including an internal space formed on the internal side thereof and the opening 310 formed at the end portion thereof, and the driving module 100 coupled to the opening 310 of the cabin 300 and configured to supply driving force to the cabin 300, in which the driving module 100 includes the independent space 150 formed on the internal side thereof in a state of being separated from the cabin 300.

The driving module 100 may include the wheel 110 provided to be in contact with the ground and configured to supply driving force, and the housing 130 including the wheel 100 accommodated therein and the floor 133 formed on the internal side thereof, in which the housing 130 is coupled to the opening 310 of the cabin 300.

The floor 133 may include the flange panel 134 provided on the internal side thereof and configured to slide from the internal side of the floor 133 to protrude to the external side of the floor 133, and the flange panel 134 may be inserted into the cabin 300 in a state in which the driving module 100 is coupled to the cabin 300.

The housing 130 may include the wheel housing portion 135 configured to allow the wheel to be accommodated therein, and the roof portion 137 extending upwards from the wheel housing portion 135.

The housing 130 may include the sliding rail 180 provided on the internal side of the roof portion 137, and the sliding rail 180 may include the display 190 movably provided thereon and configured to transmit an image.

The wheel housing portion 135 may include a shape protruding toward the cabin, the cabin 300 may include the indented groove 315 indented inwards and formed at the lower portion of the opening 310, and the wheel housing portion 135 may be inserted into the indented groove 315 of the cabin 300, enabling the driving module 100 and the cabin 300 to be coupled to each other.

The cabin 300 may include the lifting portion 330 provided at the lower portion thereof and configured to separate the cabin 300 from the ground. Here, the lifting portion 330 may protrude toward the ground to lift the cabin 300 when the driving module 100 and the cabin 300 are separated from each other, and may be accommodated in the cabin 300 when the driving module 100 and the cabin 300 are coupled to each other.

The cabin 300 may include the openings 310 respectively formed at opposite end portions thereof, and each of the pair of driving modules 100 may be coupled to a corresponding one of the opposite end portions of the cabin 300 to provide a driving force to the cabin 300.

As is apparent from the above description, the present disclosure provides a vehicle configured for being used as a means of transportation when a cabin and a driving module are coupled to each other. Furthermore, when the cabin and the driving module are separated from each other, the cabin itself may form a communal space, and the driving module itself may provide a relaxation area.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A driving module configured to be separable from or couplable to an end portion of a cabin including an internal side and to supply driving force to the cabin when the driving module is coupled to the end portion of the cabin, the driving module comprising:
a wheel provided in contact with a ground and configured to supply the driving force; and
a housing including the wheel accommodated in the housing and a floor formed on an internal side of the housing, the housing being selectively coupled to the end portion of the cabin,
wherein the housing includes an independent space formed on the internal side of the housing in a state of being separated from the cabin.

2. The driving module of claim 1, wherein the housing further includes:
a wheel housing portion configured to accommodate the wheel on an internal side of the wheel housing portion; and
a roof portion formed to extend upwards from the wheel housing portion.

3. The driving module of claim 2,
wherein the housing further includes a sliding rail provided on an internal side of the roof portion, and
wherein a display is movably mounted on the sliding rail and configured to transmit an image.

4. The driving module of claim 3, wherein the display is hinged to an end portion of the sliding rail to be rotatable about the end portion of the sliding rail.

5. The driving module of claim 3, wherein the display serves, when being located at a first end portion of the sliding rail, as a light blocking film and serves, when being located at a second end portion of the sliding rail, as an electronic display board configured to allow the image to be viewed from outside thereof.

6. The driving module of claim 1,
wherein the housing further includes an accommodation space provided at an upper end portion of the housing and configured to allow a display to be accommodated in the accommodation space, and
wherein the display is configured to slide in the accommodation space and protrude out of the housing to serve as a light blocking film.

7. The driving module of claim 6, wherein the display is a curved display.

8. The driving module of claim 1, wherein the housing further includes a sittable seat provided on the internal side of the housing.

9. The driving module of claim 8, wherein the seat is rotatably provided on the internal side of the housing through a hinge.

10. The driving module of claim 1,
wherein the floor includes a flange panel provided on an internal side of the floor, and
wherein the flange panel is configured to slide from the internal side of the floor and protrude to an external side of the floor.

11. The driving module of claim 10, wherein the flange panel protrudes to the external side of the floor in response that the driving module and the cabin are separated from each other, expanding the independent space, and is inserted into the cabin in response that the driving module and the cabin are coupled to each other.

12. The driving module of claim 2, wherein the wheel housing portion includes a shape protruding toward the cabin, and the wheel housing portion is coupled to the cabin from an external side of the cabin.

13. A vehicle comprising:
a cabin including an internal space formed on an internal side of the cabin and an opening formed at an end portion of the cabin; and
a driving module selectively coupled to the opening of the cabin and configured to supply driving force to the cabin, wherein the driving module includes an independent space formed on an internal side of the driving module in a state of being separated from the cabin.

14. The vehicle of claim 13, wherein the driving module further includes:
a wheel provided to be in contact with a ground and configured to supply the driving force; and
a housing including the wheel accommodated in the housing and a floor formed on an internal side of the housing, the housing being selectively coupled to the opening of the cabin.

15. The vehicle of claim 14,
wherein the floor includes a flange panel provided on an internal side of the floor and configured to slide from the internal side of the floor to protrude to an external side of the floor, and
wherein the flange panel is inserted into the cabin in a state in which the driving module is coupled to the cabin.

16. The vehicle of claim 14, wherein the housing further includes:
a wheel housing portion configured to accommodate the wheel on an internal side of the wheel housing portion; and
a roof portion formed to extend upwards from the wheel housing portion.

17. The vehicle of claim 16,
wherein the housing further includes a sliding rail provided on an internal side of the roof portion, and
wherein a display is movably mounted on the sliding rail and configured to transmit an image.

18. The vehicle of claim 16, wherein the wheel housing portion includes a shape protruding toward the cabin, the cabin includes an indented groove indented inwards and formed at a lower portion of the opening, and the wheel housing portion is inserted into the indented groove of the cabin, enabling the driving module to be coupled to the cabin.

19. The vehicle of claim 13,
wherein the cabin includes a lifting portion provided at a lower portion of the cabin and configured to separate the cabin from a ground, and
wherein the lifting portion protrudes, in response that the driving module and the cabin are separated from each other, toward the ground to lift the cabin and is accommodated in the cabin in response that the driving module and the cabin are coupled to each other.

20. The vehicle of claim 13,
wherein the driving module is in a pair and the opening of the cabin is in pair, and
wherein the pair of openings is formed at opposite end portions of the cabin, and each of the pair of driving modules is coupled to a corresponding one of the opposite end portions of the cabin to supply the driving force to the cabin.
